(19) United States
(12) Patent Application Publication
(10) Pub. No.: US 2011/0109849 A1
(43) Pub. Date: May 12, 2011

(54) ACRYLIC COMPOSITION FOR OPTICAL MEMBERS, PROTECTIVE FILM FOR OPTICAL MEMBERS, POLARIZING PLATE, AND LIQUID CRYSTAL DISPLAY

(76) Inventors: Hyun Jee Yoo, Daejeon (KR); Hyun Ju Cho, Gyeongsangnam-do (KR); Hak Lim Kim, Chungcheongbuk-do (KR); Jang Soon Kim, Daejeon (KR); Mun Seop Song, Daejeon (KR)

(21) Appl. No.: 13/001,773

(22) PCT Filed: Jul. 1, 2009
(86) PCT No.: PCT/KR09/03603

§ 371 Date: Dec. 28, 2010

(30) Foreign Application Priority Data
Jul. 1, 2008 (KR) 10-2008-0063379
Jul. 1, 2008 (KR) 10-2008-0063380

(51) Int. Cl. G02F 1/1335; C08L 33/08; B32B 7/12; B32B 5/00

(52) U.S. Cl. 349/96; 522/152; 522/79; 522/40; 522/33; 522/39; 522/64; 428/355 CN; 428/337; 428/339

(57) ABSTRACT

The present invention relates to an acrylic composition for optical elements, a protective film for optical elements, a polarizer, and a liquid crystal display (LCD). According to the present invention, by adding a proper amount of an antistatic agent to a composition including a photo-polymerizable acrylic polymer, which is cured by irradiation of radial rays such as ultraviolet rays (UVs), and a polymerization initiator at a predetermined ratio, an aging process can be skipped during curing, thereby simplifying a preparation process and providing an acrylic composition for optical elements, a protective film for optical elements, a polarizer, and an LCD, which have excellent anti-static property during peeling or use, and superior endurance reliability, workability, adhesive property, wettability, and optical characteristics.

### DETAILED DESCRIPTION OF THE INVENTION

1. Technical Field

The present invention relates to an acrylic composition for optical elements, a protective film for optical elements, a polarizer, and a liquid crystal display (LCD).

2. Background Art

A liquid crystal display (LCD) is a device for displaying an image by injecting liquid crystals between two thin glass substrates. In the device, the molecular arrangement of the liquid crystals changes with application of voltage through electrodes connected to the liquid crystals, and thus the transmissivity of light passing through the liquid crystals also changes, thus displaying a picture or a color. The LCD has drawn much attention from various fields due to its advantage of low power consumption and capability of being made flat and thin.

With the increasing demand for LCDs, films having optical characteristics such as polarizers are also in demand, and high speed LCD production processes are also required. In addition, with the increasing speed of the production lines, various raw and subsidiary materials are also increasingly demanded and productivity of the raw and subsidiary materials is also regarded as an important issue.

Surface protective films applied to optical elements such as polarizers are generally prepared by sequential processes of application of a pressure-sensitive adhesive composition to a base, drying, lamination with releasing films, aging, inspection, slitting, and packaging. In each stage, more than several hours are required for aging of a pressures-sensitive adhesive. The aging process is performed for reaction between a crosslinking agent and a pressure-sensitive adhesive resin mixed in a pressure-sensitive adhesive composition, during which the cohesive strength and endurance of the pressure-sensitive adhesive are improved. Accordingly, to produce optical elements such as polarizer, temperature/humidity control facilities for controlling the foregoing aging conditions and spaces therefor are required, increasing processing cost and thus weakening product competiveness.

With the realization of high-speed polarizer production, destruction of devices such as TFT ICs has been observed during the peeling of a protective film, which is attributed to static electricity generation not common in the conventional processes, resulting in a poor LCD.

To solve the problem, Korean Patent Publication No. 2004-0030919 discloses a technique for obtaining antistatic property by adding an organic salt to a pressure-sensitive adhesive. However, according to this technique, high priced organic salt has to be used and only surface resistance is reduced without predicting the variations of constant voltage caused by static electricity generated during the peeling.

Japanese Laid-Open Patent Publication No. 2004-287199 discloses a pressure-sensitive adhesive including an isocyanate crosslinking agent and an ionic conductive polymer having a hydroxyl group. However, the adhesive property and the rheological property are changed, due to the mixed isocyanate crosslinking agent, so the anti-static and adhesive properties are difficult to control.

Japanese Laid-Open Patent Publication No. Hei6-128539 discloses a pressures-sensitive adhesive composition including an isocyanate crosslinking agent, polyether polyol, and metal salt. However, according to this technique, the degree of cross-linking is affected by the used crosslinking agent and surface migration and adhesive property degradation occur due to the hydrophilicity of alkyleneoxide of polyether polyol.

### TECHNICAL PROBLEM

An object of the present invention is to provide an acrylic composition for optical elements, a protective film for optical elements, a polarizer, and a liquid crystal display (LCD).

### TECHNICAL SOLUTION

The present invention provides, as a means for achieving the foregoing object, an acrylic composition for optical elements, the acrylic composition including 100 parts by weight of a photo-polymerizable acrylic polymer, the photo-polymerizable acrylic polymer including a main chain which is a polymer of a monomer mixture comprising 90 to 99.9 parts by weight of a (meth)acrylic acid ester monomer and 0.01 to 10 parts by weight of a polar monomer; and 0.06 to 16 parts by weight of a photo-polymerizable group-containing compound bonded to the main chain; 0.01 to 9 parts by weight of an antistatic agent; and 0.01 to 9 parts by weight of a polymerization initiator.

The present invention provides, as another means for achieving the foregoing object, a protective film for optical elements, the protective film including a base; and a cured product of the acrylic composition according to the present invention, the cured product being formed on the base.

The present invention provides, as another means for achieving the foregoing object, a polarizer having the protective film according to the present invention attached on a side or both sides thereof.

The present invention provides, as another means for achieving the foregoing object, a liquid crystal display (LCD) having the polarizer according to the present invention attached on a side or both sides of a liquid crystal panel.

### EFFECTS OF THE INVENTION

According to the present invention, by adding a proper amount of an antistatic agent to a composition including a photo-polymerizable acrylic polymer, which has introduced thereto a photo-activating group capable of causing crosslinking reaction by radicals generated by an initiator through light irradiation, and a polymerization initiator at a predetermined ratio, an aging process can be skipped during curing, thereby simplifying a preparation process and providing an acrylic composition for optical elements, a protective film for optical elements, a polarizer, and an LCD, which have excellent anti-static property during peeling or use, and superior endurance reliability, workability, adhesive property, wettability, and optical characteristics.

### MODE FOR CARRYING OUT THE INVENTION

The present invention relates to an acrylic composition for optical elements, the acrylic composition including 100 parts by weight of a photo-polymerizable acrylic polymer, the photo-polymerizable acrylic polymer including a main chain which is a polymer of a monomer mixture comprising 90 to 99.9 parts by weight of a (meth)acrylic acid ester monomer and 0.01 to 10 parts by weight of a polar monomer; and 0.06 to 16 parts by weight of a photo-polymerizable group-containing compound bonded to the main chain; 0.01 to 9 parts by weight of an antistatic agent; and 0.01 to 9 parts by weight of a polymerization initiator.

Hereinafter, the acrylic composition according to the present invention will be described in detail.

The photo-polymerizable acrylic polymer included in the acrylic composition according to the present invention includes a main chain and a photo-polymerizable group-containing compound bonded to the main chain to provide a photo-activating group, and thus can cause crosslinking reaction by radicals generated by an initiator through light irradiation.

More specifically, the photo-polymerizable acrylic polymer includes a main chain, which is a polymer of a monomer mixture including 90 to 99 parts by weight of a (meth)acrylic acid ester monomer and 1 to 10 parts by weight of a polar monomer; and 0.06 to 16 parts by weight of a photo-activating group-containing compound bonded to the main chain.

A type of the (meth)acrylic acid ester monomer included in the main chain of the photo-polymerizable acrylic polymer is not specifically limited, and for example, alkyl (meth)acrylate may be used. In this case, if an alkyl group included in the monomer is excessively long, the cohesive strength of the pressure-sensitive adhesive may be degraded and glass transition temperature or pressure-sensitive adhesive property may become difficult to regulate. Thus, it is desirable to use a (meth)acrylic acid ester monomer having an alkyl group of 1 to 14 carbon atoms. Examples of such a monomer may include mixtures of one kind or two or more kinds of methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylbutyl (meth)acrylate, 2-ethylhexyl (meth)acrylate, n-octyl (meth)acrylate, isooctyl (meth)acrylate, isononyl (meth)acrylate, lauryl (meth)acrylate, and tetradecyl (meth)acrylate.

In the monomer mixture, the (meth)acrylic acid ester monomer may be included in a content of 90 to 99.9 parts by weight, preferably 99 to 99.9 parts by weight with respect to the polar monomer. If the content is less than 90 parts by weight, the initial adhesive strength of the pressure-sensitive adhesive may be degraded. If the content exceeds 99 parts by weight, a problem may occur in endurance due to cohesive strength degradation.

The polar monomer included in the monomer mixture forming the main chain serves to provide the main chain with a polar functional group as a part capable of reacting with the photo-polymerizable group-containing compound. Examples of the polar functional group may include a hydroxy group, a carboxyl group, an isocyanate group, an amino group, and an epoxy group, and in the present invention, it is desirable to use, but not limited to, a hydroxy group or a carboxyl group.

In the present invention, the polar monomer is not specifically limited if it has the polar functional group and an unsaturated double bond in its molecules. For example, in the present invention, as the polar monomer, a mixture of one kind or two or more kinds of 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethylene glycol (meth)acrylate, 2-hydroxypropylene glycol (meth)acrylate, (meth)acrylic acid, 2-(meth)acryloyloxy acetic acid, 3-(meth)acryloyloxy propylacid, 4-(meth)acryloyloxy butylacid, fumaric acid, acrylic acid dimer, itaconic acid, maleic acid, and maleic acid anhydride, but not limited thereto, may be used.

In the present invention, the content of the polar monomer is determined according to the physical properties of the pressure-sensitive adhesive and a content of photo-polymerizable group to be introduced to the main chain, without being specifically limited. In the present invention, for example, the monomer mixture may include 0.01 to 10 parts by weight, preferably 0.01 to 5 parts by weight, more preferably 0.01 to 1 part by weight of the polar monomer with respect to the (meth)acrylic acid ester monomer. If the content is less than 0.01 part by weight, the amount of a photo-activating group (photo-polymerizable group) that can be introduced to the main chain is insufficient, lowering cohesive strength. If the content exceeds 10 parts by weight, compatibility and/or the flow feature may be degraded, lowering economic efficiency due to increase of raw material cost.

The photo-polymerizable acrylic polymer according to the present invention may include, in addition to the main chain including the foregoing component, a photo-polymerizable group containing compound which is bonded to the main chain, preferably to a side chain of the main chain, to provide the photo-polymerizable group to the polymer.

A detailed type of the compound is not specifically limited if it includes 1 to 5, preferably 1 or 2 photo-polymerizable groups (e.g., photo-polymerizable carbon-carbon double bond) per molecule, and has a functional group capable of reacting with a polar functional group included in the main chain. Examples of the functional group capable of reacting with the functional group of the main chain may include, but not limited to, an isocyanate group, an epoxy group, a silane group, and a carboxyl group. For example, if a hydroxy group or a carboxyl group is introduced to the main chain, the functional group included in the compound may be an isocyanate group, an epoxy group, or a chlorosilane group. If an amino group or a substituted amino group is introduced to the main chain, the functional group included in the compound may be an isocyanate group. If an epoxy group is included in the main chain, the functional group included in the compound may be a carboxyl group.

Detailed examples of the photo-activating group-containing compound that can be used in the present invention may include, but not limited to, one kind or two or more kinds of 2-isocyanatoethyl (meth)acrylate, 1,1-bis(acryloyloxymethyl)ethyl isocyanate, (meth)acryloyloxy ethyl isocyanate, metha-isopropenyl-α,α-dimethylbenzylisocyanate, methacryloylisocyanate, or allyl isocyanate; an acryloyl monoisocyanate compound obtained by causing a diisocyanate compound or a polyisocyanate compound to react with (meth)acrylic acid 2-hydroxyethyl; an acryloyl monoisocyanate compound obtained by causing a diisocyanate compound or a polyisocyanate compound, a polyol compound, and (meth)acrylic acid 2-hydroxyethyl to react; (meth)acrylic acid glycidyl; (meth)acrylic acid; or 3-methacryloxypropyldimethylchlorosilane.

In the present invention, the content of the photo-activating group-containing compound is selected according to the desired use, without being specifically limited. For example, the photo-activating group-containing compound may be included in a content of 0.06 to 16 parts by weight, preferably 0.1 to 8 parts by weight, more preferably 1 to 6 parts by weight, most preferably 0.1 to 2 parts by weight with respect to the (meth)acrylic acid ester monomer or the polar monomer included in the main chain. If the content of the photo-activating group-containing compound is less than 0.06 part by weight, the peeling strength excessively increases, degrading peeling processing efficiency. If the content exceeds 16 parts by weight, the cohesive strength of the pressure-sensitive adhesive excessively increases, degrading endurance reliability. In the present invention, especially taking into account economic efficiency due to increase in raw material cost, the photo-activating group-containing compound may be used in a content of 3% or less by weight ratio, preferably 2% or less by weight ratio, more preferably 1% or less by weight ratio, relative to the main chain.

The photo-polymerizable acrylic polymer according to the present invention may have a weight average molecular weight of 200,000 to 1,000,000. If the weight average molecular weight of the polymer is less than 200,000, the cohesive strength of the pressure-sensitive adhesive is degraded and thus there may be residues in an adherend. If the weight average molecular weight exceeds 1,000,000, the viscosity excessively increases, hindering smooth reaction with the photo-polymerizable group.

The photo-polymerizable acrylic polymer according to the present invention preferably has a glass transition temperature of −40° C. or less. If the glass transition temperature of the polymer exceeds −40° C., wettability with an adherend may be deteriorated. In the present invention, the lower limit of the glass transition temperature of the polymer is not specifically limited, and for example, it may be properly controlled in a range of −80° C. or more.

In the present invention, a method of preparing the photo-polymerizable acrylic polymer is not specially limited. In the present invention, for example, the photo-polymerizable acrylic polymer may be prepared by first preparing an acrylic polymer forming a main chain, and then introducing a photo-polymerizable group to the polymer by causing the polymer, e.g., a polar group introduced to the polymer, to react with the photo-activating group-containing compound.

In this case, a method of preparing the polymer forming the main chain is not specially limited, and for example, a general polymerization method such as solution polymerization, photo-polymerization, bulk polymerization, suspension polymerization, or emulsion polymerization may be used to prepare the polymer. In the present invention, it is desirable to use solution polymerization, and more specifically, an initiator is mixed in a state where monomers are evenly mixed and polymerization temperature is 50 to 140° C. The initiator that can be used may be an azo-based polymerization initiator such as azo-bisisobutyronitrile or azobiscyclohexane carbonitrile; and/or a common initiator like peroxide such as benzoyl peroxide or acetyl peroxide.

A method of causing the prepared main chain to react with the photo-activating group-containing compound is not specially limited, and for example, the polymer forming the main chain and the photo-activating group-containing compound may react at room temperature to 40° C. at atmospheric pressure for 4 to 48 hours. The reaction may be performed by using a organic tin catalyst in a solvent such as acetic acid ethyl.

The acrylic composition according to the present invention includes, in addition to the foregoing components, an antistatic agent. In this case, a type of the antistatic agent is not specifically limited if it has excellent compatibility with the photo-polymerizable acrylic polymer and can give antistatic performance without affecting the transparency, workability, and endurance reliability of the pressure-sensitive adhesive.

Examples of the antistatic agent that can be used in the present invention may include i) a mixture of an alkyleneoxide-containing compound and metal salt; and ii) a mixture of a compound capable of forming a coordinate covalent bond and metal salt, and in the present invention, a mixture of one kind or two or more kinds of the examples may be used.

In the present invention, the alkyleneoxide-containing compound included in the antistatic agent i) may form a complex with components of the metal salt. Since the alkyleneoxide-containing compound is included in the antistatic agent, together with the metal salt, for example, by adding a small amount of antistatic component (e.g., metal salt), remarkably superior antistatic performance can be provided to the pressure-sensitive adhesive while maintaining or improving the endurance reliability, transparency, and workability of the pressure-sensitive adhesive.

A detailed type of the alkyleneoxide-containing compound that can be used in the present invention is not particularly limited if it can perform the foregoing function, and may include, for example, a compound including an alkylene oxide unit having 1 to 12 carbon atoms, preferably 1 to 8 carbon atoms, more preferably 1 to 4 carbon atoms. To be more specific, a compound including an ethyleneoxide and/or propyleneoxide unit may be used.

More specifically, the alkyleneoxide-containing compound may be, for example, a compound expressed by:

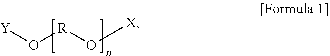

where R represents alkylene, Y represents hydrogen, alkyl, or —C(═O)R₁, X represents hydrogen, hydroxy, alkyl, or —C(═O)R₂, and n represents 1 to 120, in which R₁ and R₂ represent, independently of each other, hydrogen or an alkyl group.

In the definition of Formula 1, alkylene indicates alkylene of 1 to 12 carbon atoms, preferably 1 to 8 carbon atoms, more preferably 1 to 4 carbon atoms, and more specifically indicates ethylene or propylene.

In the definition of Formula 1, alkyl indicates alkyl of 1 to 12 carbon atoms, preferably 1 to 8 carbon atoms, more preferably 1 to 4 carbon atoms.

In Formula 1, n may indicate preferably 1 to 80, more preferably 1 to 40.

A detailed example of the compound expressed with Formula 1 may include polyalkyleneglycol (e.g., polyethyleneglycol or polypropyleneglycol), fatty acid alkyl ester of polyalkyleneglycol (e.g., polyethyleneglycol or polypropyleneglycol), and carboxyl acid ester of polyalkyleneglycol (e.g., polyethyleneglycol or polypropyleneglycol).

In the present invention, the alkyleneoxide-containing compound preferably has a weight average molecular weight of 100 to 10,000. If the weight average molecular weight is less than 100, complex forming performance may be degraded. If the weight average molecular weight exceeds 10,000, the flow feature of the pressure-sensitive adhesive may be deteriorated. A type of the metal salt included in the antistatic agent i) is not particularly limited, and for example, it may be metal salt including alkali metal cations or alkali earth metal anions. In this case, detailed examples of the cations may include one kind or two or more kinds of lithium ions (Li⁺), natrium ions (Na⁺), potassium ions (K⁺), rubidium ions (Rb⁺), cesium ions (Cs⁺), beryllium ions (Be²⁺), magnesium ions (Mg²⁺), calcium ions (Ca²⁺), strontium ions (Sr²⁺), and barium ions (Ba²⁺), and preferably one kind or two or more kinds of lithium ions (Li⁺), natrium ions (Na⁺), potassium ions (K⁺), cesium ions (Cs⁺), beryllium ions (Be²⁺), magnesium ions (Mg²⁺), calcium ions (Ca²⁺), and barium ions (Ba²⁺). In terms of ion stability and mobility in the pressure-sensitive adhesive, it is desirable to use, but not limited to, lithium ions (Li⁺).

In the present invention, a type of the anions included in the metal salt is not specifically limited, and for example, it may be selected from, but not limited to, a group consisting of fluoride (F⁻), chloride (Cl⁻), bromide (Br⁻), iodide (I⁻), perchlorate (ClO₄⁻), hydroxide (OH⁻), carbonate (CO₃²⁻), carboxylate (e.g. CH₃CO₂⁻), azide anions (N₃⁻), phosphate (HPO₄²⁻), nitrate (NO₃⁻), sulfonate (SO₄²⁻), methylbenzelsulfonate (CH₃(C₆H₄)SO₃⁻), p-toluenesulfonate (CH₃C₆H₄SO₃⁻), carboxybenzelsulfonate (COOH(C₆H₄)SO₃⁻), triploromethanesulfonate (CF₃SO₂⁻), benzonate (C₆H₅COO⁻), acetate (CH₃COO⁻), triploroacetate (CF₃COO⁻), tetrafluoroborate (BF₄⁻), tetrabenzylborate (B(C₆H₅)₄⁻), hexafluorophosphate (PF₆⁻), trispentafluoroethyl trifluorophosphate (P(C₂F₅)₃F₃⁻)⁻), bistrifluoromethanesulfonimide (N(SO₂CF₃)₂⁻), bispentafluoroethanesulfonimide (N(SOC₂F₅)₂⁻), bistrifluoromethanecarbonylimide (N(COC₂F₅)₂⁻), bispentafluoroethanecarbonylimide (N(COC₂F₅)₂⁻), bisperfluorobutanesulfonimide (N(SO₂C₄F₉)₂⁻), bisperfluorobutanecarbonylimide (N(COC₄F₉)₂⁻), tristrifluoromethansulfonylmethide (C(SO₂CF₃)₃), and tristrifluoromethanecarbonylmethide (C(SO₂CF₃)₃⁻).

In the present invention, among the above anions, it is desirable to use, but not limited to, an anion including a perfluoroalkyl group which can efficiently function as electron withdrawing and has excellent hydrophobic property.

In the acrylic composition according to the present invention, the metal salt included in the antistatic agent i) may be included such that a molar ratio ([RO]/[Mⁿ⁺]) of cations (Mⁿ⁺, in which n is 1 or 2) included in the salt with respect to the alkylene oxide unit (RO) of the alkyleneoxide-containing compound is 1 to 100. If the mol ratio is less than 1, the amount of addition of the metal salt relatively increases, degrading antistatic performance or physical properties required for optical elements such as transparency or endurance. If the mol ratio exceeds 100, the density of ions in the pressure-sensitive adhesive excessively decreases, deteriorating antistatic performance.

A type of the compound capable of forming a coordinate covalent bond that can be included in the antistatic agent ii) is not particularly limited if it stably forms a complex with the metal salt to give superior antistatic performance while maintaining or improving the endurance reliability, transparency, and workability of the pressure-sensitive adhesive.

In the present invention, for example, as the compound capable of forming a coordinate covalent bond, one kind or two or more kinds of an oxalate group-containing compound, a diamine group-containing compound, a polyvalentcarboxyl group-containing compound, and a β-ketone group-containing compound may be used, among which it is desirable to use, but not limited to, an oxalate group-containing compound. The oxalate group-containing compound locally forms negative charges by a carbon-oxygen double bond included in the molecular structure and an unshared electron pair of oxygen, and efficiently forms a complex with cations of the metal salt by the negative charges.

The oxalate group-containing compound may be, for example, a compound expressed by:

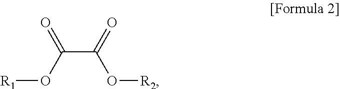

where R₁ and R₂ indicate, independently of each other, hydrogen, halogen, alkyl, alkoxy, alkenyl, alkynyl aryl, aryl alkyl, or aryloxy.

In the definition of Formula 2, alkyl, alkoxy, alkenyl, or alkynyl may have a straight-chain-type, branch-type, or ring-type structure.

In the definition of Formula 2, alkyl or alkoxy may be alkyl or alkoxy of 1 to 20 carbon atoms, preferably 1 to 12 carbon atoms, more preferably 1 to 8 carbon atoms, most preferably 1 to 4 carbon atoms, and the aryl group may be an aryl group of 6 to 30 carbon atoms, preferably 6 to 20 carbon atoms.

In the present invention, detailed examples of the compound expressed by Formula 2 may include, but not limited to, one kind or two or more kinds of diethyloxalate, dimethyloxalate, dibutyloxalate, di-tert-butyloxalate, and bis(4-methylbenzyl)oxalate.

The diamine group-containing compound may be expressed by:

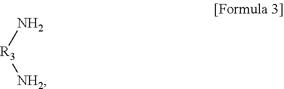

where R₃ indicates alkylene or alkenylene.

In the definition of Formula 3, alkylene may be alkylene of 1 to 12 carbon atoms, preferably 1 to 8 carbon atoms, and alkenylene may be alkenylene of 2 to 10 carbon atoms, preferably 2 to 8 carbon atoms.

In the definition of Formula 3, alkylene or alkenylene may have a linear-type, branch-type, or ring-type structure.

In the present invention, detailed examples of the compound expressed by Formula 3 may include, but not limited to, one kind or two or more kinds of ethylenediamine, 1,2-diaminopropane, and diaminobutane.

The polyvalentcarboxyl group-containing compound is a compound including polycarboxyl acid or carboxylate, and for example, may be a compound including functional groups expressed by:

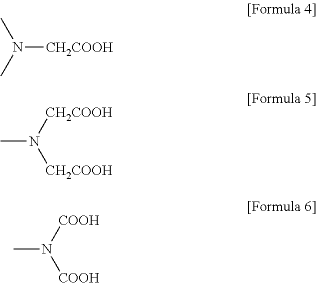

In the present invention, detailed examples of the polyvalentcarboxyl group-containing compound may include, but not limited to, mixtures of one kind or two or more kinds of ethylenediamine-N,N,N′,N′-tetraacetic acid (EDTA), N,N,N′,N″,N″-diethylenetriamine pentaacetic acid (DTPA), 1,4,7,10-tetraazacyclododecane-N,N′,N″,N′″-tetraacetic acid (DOTA), 1,4,7,10-tetraazacyclododetane-N,N′,N″-triacetic acid (DO3A), trans(1,2)-cyclohexanodiethylenetriamine pentaacetic acid, or N,N-biscarboxymethylglycine.

In the present invention, the polyvalentcarboxyl group-containing compound may be a compound expressed by:

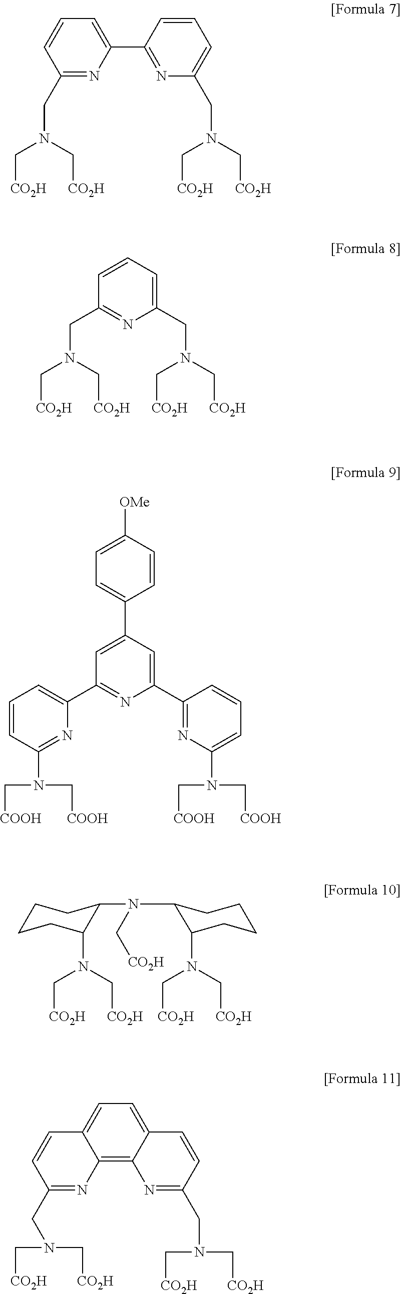

In the present invention, the β-ketone group-containing compound may be, for example, a compound expressed by:

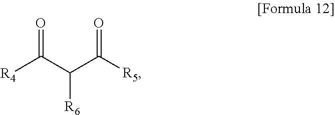

where R₄ and R₅ indicate, independently of each other, alkyl, alkoxy, alkenyl, alkynyl, aryl, arylalkyl, or aryloxy, and R₆ indicates hydrogen, alkyl, alkoxy, alkenyl, alkynyl, aryl, aryl alkyl, or aryloxy.

In the definition of Formula 12, alkyl, alkoxy, alkenyl, or alkynyl may have a straight-chain-type, branch-type, or ring-type structure.

In the definition of Formula 12, alkyl or alkoxy may be alkyl or alkoxy of 1 to 20 carbon atoms, preferably 1 to 12 carbon atoms, more preferably 1 to 8 carbon atoms, most preferably 1 to 4 carbon atoms, and aryl may be aryl of 6 to 30 carbon atoms, preferably 6 to 20 carbon atoms.

Detailed examples of the compound according to Formula 12 that can be used in the present invention may include, but not limited to, one kind or two or more kinds of 2,4-pentadion, 1-bezoylacetone, and ethylacetoacetate.

A type of the metal salt that can be included in the antistatic agent ii), together with the compound capable of forming a coordinate covalent bond is not specially limited, and for example, the same metal salt as that included in the antistatic agent i) may be included.

The antistatic agent ii) according to the present invention may include 0.1 to 10 parts by weight of the compound capable of forming a coordinate covalent bond and 0.1 to 50 parts by weight of the metal salt. By controlling the contents of the metal salt and the compound capable of forming a coordinate covalent bond within those ranges, excellent antistatic property can be added to the pressure-sensitive adhesive while maintaining or improving superior physical properties such as the endurance reliability, workability, and transparency of the pressure-sensitive adhesive.

The antistatic agent i) and/or ii) may be included in a content of 0.01 to 9 parts by weight, preferably 0.01 to 5 parts by weight relative to 100 parts by weight of the photo-polymerizable acrylic polymer. If the content of the antistatic agent is less than 0.01 part by weight, the antistatic performance may be degraded. If the content exceeds 9 parts by weight, physical properties such as the endurance reliability or transparency of the pressure-sensitive adhesive may be degraded.

The acrylic composition according to the present invention includes 0.01 to 9 parts by weight, preferably 0.01 to 5 parts by weight of a polymerization initiator relative to 100 parts by weight of the photo-polymerizable acrylic polymer. A type of the polymerization initiator that can be used in the present invention is not specially limited, and for example, a common photo-initiator which initiates polymerization reaction by generating radicals through photo-irradiation may be used. A type of the photo-initiator that can be used in the present invention is not specifically limited, and may be, but not limited to, bezoin, hydroxyketone, aminoketone, or phosphine oxide, and more specifically, benzoin, benzoin methylether, benzoin ethylether, benzoin isopropylether, benzoin n-butylether, benzoin isobutylether, acetophenone, dimethylamino acetophenone, 2,2-dimethoxy-2-penylacetophenone, 2,2-diethoxy-2-penylacetophenone, 2-hydroxy-2-methyl-1-penylpropane-1-on, 1-hydroxycyclohexylpenylketone, 2-methyl-1-[4-(methylthio)penyl]-2-molrpholino-propane-1-on, 4-(2-hydroxyethoxy)penyl-2-(hydroxy-2-propyl)ketone, benzophenone, p-penylbenzophenone, 4,4′-diethylaminobenzophenone, dichlorobenzophenone, 2-methylanthraquinone, 2-ethylanthraquinone, 2-t-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethylketal, acetophenone dimethylketal, p-dimethylamino benzoic acid ester, oligo[2-hydroxy-2-methyl-1-[4-(1-methylvinyl)penyl]propanon], and 2,4,6-trimethylbenzoyl-diphenyl-phorsphineoxide. In the present invention, one kind or two or more kinds of the foregoing examples may be used.

In the present invention, the polymerization initiator may be included in a content of 0.01 to 9 parts by weight, preferably 0.01 to 5 parts by weight relative to 100 parts by weight of the acrylic polymer. If the content is less than 0.01, the polymerization reaction may not be performed smoothly. If the content exceeds 9 parts by weight, the physical properties such as endurance reliability or transparency of the pressure-sensitive adhesive may be degraded.

The acrylic composition according to the present invention may further include 0.1 to 10 parts by weight, preferably 0.5 to 6 parts by weight of a photo-polymerizable compound relative to 100 parts by weight of the acrylic polymer. By appropriately adding this compound to the acrylic composition, physical properties such as cohesive strength or endurance reliability of the pressure-sensitive adhesive can be further enhanced.

A type of the photo-polymerizable compound that can be used in the present invention is not specially limited, and for example, a compound having two or more photo-polymerizable groups (e.g., acrylate groups) in its molecules and a molecular weight or a weight average molecular weight of 100 to 10,000 may be used.

Detailed examples of the photo-polymerizable compound that can be used in the present invention may include multifunctional acrylate, urethane acrylate oligomer, and epoxy acrylate oligomer.

A type of the multifunctional acrylate that can be used herein is not particularly limited, and examples thereof may include, but not limited to bifunctional acrylate such as 1,4-butanediol di(meth)acrylate, 1,6-hexanediol di(meth)acrylate, neopentylglycol di(meth)acrylate, polyethyleneglycol di(meth)acrylate, neopentylglycol adipate di(meth)acrylate, hydroxyl puivalic acid neopentylglycol di(meth)acrylate, dicyclopentanyl di(meth)acrylate, caprolactone modified dicyclopentenyl di(meth)acrylate, ethyleneoxide modified di(meth)acrylate, di(meth)acryloxy ethyl isocyanurate, allylated cyclohexyl di(meth)acrylate, tricyclodecanedimethanol(meth)acrylate, dimethylol dicyclopentane di(meth)acrylate, ethyleneoxide modified hexhydrophtalic acid di(meth)acrylate, tricyclodecane dimethanol (meth)acrylate, neopentylglycol modified trimethylpropane di(meth)acrylate, adamantane di(meth)acrylate, or 9,9-bis[4-(2-acryloyloxyetoxt)penyl]enefluorine; trifunctional acrylate such as trimethylolpropane tri(meth)acrylate, dipentaerythritol tri(meth)acrylate, propionic modified dipentaerythritol tri(meth)acrylate, pentaerythritol tri(meth)acrylate, propyleneoxide modified trimethylolpropane tri(meth)acrylate, trifunctional urethane (meth)acrylate, or tris(meth)acryloxyethylisocyanurate; tetrafunctional acrylate such as diglycerin tetra(meth)acrylate, or pentaerythritol tetra(meth)acrylate; octafunctional acrylate such as propionic acid modified dipentaerythritol penta(meth)acrylate; and hexafunctional acrylate such as dipentaerythritol hexa(meth)acrylate, caprolactone modified dipentaerythritol hexa(meth)acrylate, or urethane (meth)acrylate(e.g., reactants between an isocyanate monomer and trimethylolpropane tri(meth)acrylate).

Examples of the urethane acrylate oligomer that can be used herein may include, but not limited to, oligomer prepared by reacting (meth)acrylate including a hydroxy group with a urethane prepolymer having isocyanate in its terminal portion prepared by reacting a polyester type or polyether type polyol compound with an isocyanate compound. Detailed examples of the isocyanate compound may include, but not limited to, 2,4-tolylene diisocyanate, 2,6-tolylene diisocyanate, 1,3-xylene diisocyanate, 1,4-xylene diisocyanate, and dipenylmethane-4,4′-diisocyanate, and examples of the (meth)acrylate may include, but not limited to, 2-hydroxyethyl (meth)acrylate, 2-hydroxypropyl (meth)acrylate, and polyethyleneglycol (meth)acrylate.

The epoxy acrylate oligomer that can be used herein may be oligomer prepared by reacting aromatic or non-aromatic epoxy resin having an epoxy group at both terminals with a compound such as (meth)acrylic acid.

In the present invention, the photo-polymerizable compound may be included in a content of 0.1 to 10 parts by weight relative to 100 parts by weight of the acrylic polymer. If the content is less than 0.1 part by weight, the cohesive strength improving effect may not be sufficient. If the content exceeds 10 parts by weight, the wettability of the pressure-sensitive adhesive may be deteriorated.

In a range that does not affect the effects of the present invention, the acrylic composition according to the present invention may further include one or more additives selected from a group consisting of a silane coupling agent, a tackifier, epoxy resin, a crosslinking agent, a UV stabilizer, an antioxidant, a coloring agent, a reinforcing agent, a filler, an anti-foamer, a surfactant, and a plasticizer.

The present invention also relates to a protective film for optical elements, which includes a base; and a cured product of the acrylic composition according to the present invention, the cured product being formed on the base.

As mentioned above, the pressure-sensitive adhesive according to the present invention allows the aging process to be skipped, thereby simplifying the manufacturing process. In addition, the pressure-sensitive adhesive has excellent endurance reliability, workability, and transparency, and shows superior antistatic property, thus being effectively applicable to various optical devices or display devices which require antistatic properties during manufacturing or use. In particular, a pressure-sensitive adhesive sheet including a transparent base; and the pressure-sensitive adhesive according to the present invention formed on the transparent base can be effectively used as a surface protective film for protecting optical elements such as a polarizer, a wave plate, a phase retardation plate, an optical compensation film, a reflective sheet, and a brightness enhancing film.

The base used in the protective film according to the present invention may be a general transparent film in this field, examples of which may include a plastic film such as a polyester film (e.g., a polyethyleneterephtalate film, polybutyleneterephtalate), a polytetrafluoroethylene film, a polyethylene film, a polypropylene film, a polybuten film, a polybutadiene film, a vinyl chloride copolymer, or a polyamide film. The base film may be formed as a single layer or a laminated structure of two or more layers. The base film may further include a functional layer such as an anti-smudge layer or an antistatic layer. In the present invention, surface treatment such as primer treatment may be performed on a side or both sides of the base to improve the base adhesion.

In the present invention, the thickness of the base film may be properly selected without being specifically limited, and may be formed in a thickness of generally 5 to 500 μm, preferably 10 to 100 μm.

The thickness of the pressure-sensitive adhesive layer included in the protective film according to the present invention is not specially limited, and for example, may be 2 to 100 μm, preferably 5 to 50 μm. If the thickness of the pressure-sensitive adhesive is beyond that range, it may be difficult to form uniform pressure-sensitive adhesive layer, making the physical properties of the pressure- sensitive adhesive film non-uniform.

In the present invention, a method of forming the pressure-sensitive adhesive layer on the base is not particularly limited, and for example, the method may include applying the acrylic composition onto the base with a general means such as a bar coater and curing it, or applying the acrylic composition onto the surface of a peeling base and curing it to prepare a pressure-sensitive adhesive layer and then transferring the pressure-sensitive adhesive layer to the base by using the peeling base.

A method of curing the acrylic composition according to the present invention during preparation of the pressure-sensitive adhesive polarizer is not specifically limited, and a general method in this field may be used. However, it is desirable to use a curing method using irradiation of radial rays such as UVs or electronic rays, more preferably a curing method using irradiation of UVs.

The UV irradiation may be performed by using a means such as a high pressure mercury lamp, an induction lamp, or a xenon lamp.

The amount of irradiation in UV curing is not specifically limited if it does not damage overall physical properties and provides sufficient curing, and for example, it is preferable that the intensity of illumination is 50 to 1,000 mW/cm² and the intensity of radiation is 50 to 1,000 mJ/cm².

The present invention also relates to a polarizer having the protective film according to the present invention attached on a side or both sides thereof.

The polarizer to which the protective film is attached may include a polarizing film or polarizing element; and a protective sheet formed on a side or both sides of the polarizing film or polarizing element. The polarizer according to the present invention may further include one or more functional layers selected from a group consisting of a protective layer, a reflective layer, an anti-glare layer, a phase retardation plate, a compensation film for wide view angle, and a brightness enhancing film.

A type of the polarizing film or polarizing element forming the polarizer is not specifically limited. For example, in the present invention, as the polarizing film or polarizing element, a film prepared by adding a polarization component such as iodine or dichroic dyes onto a polyvinyl alcohol resin film and elongating it may be used. Said polyvinyl alcohol resin may comprise polyvinyl alcohol, polyvinyl formal, polyvinyl acetal and hydrolysate of ethylene-vinyl acetate copolymer, and the like. Also, there is no limitation in the thickness of the polarization film and so the polarization film may be made in conventional thickness.

In the polarizer of the present invention, a protective sheet that may be formed on a side or both sides of the polarizing film or polarizing element is a sheet that is distinguished from the protective film of the present invention. Specific kinds thereof comprise a cellulose film such as triacetyl cellulose; a polyester film such as a polycarbonate film or a polyethylene terephthalate; a polyether sulphone film; and/or a polyolefin film such as polyethylene film, polypropylene film, polyolefin film having cyclo or norbornene structure, or ethylene-propylene copolymer. At this time, the thickness of these protective sheets is also not particularly restricted. It may be formed in a usual thickness.

The present invention also relates to a liquid crystal display (LCD) including a liquid crystal panel in which the polarizer according to the present invention is attached on a face or both faces of a liquid crystal cell.

A type of a liquid crystal cell forming the LCD according to the present invention is not specifically limited, and includes a general liquid crystal cell such as of a twisted neumatic (TN) type, a super twisted neumatic (STN) type, or a vertical alignment (VA) type. A type of and a manufacturing method for other structures included in the LCD according to the present invention are not specially limited, either, and a general structure in this field can be adopted without limit.

### EMBODIMENTS

Hereinafter, the present invention will be described in more detail with reference to examples according to the present invention and comparative examples which do not accord to the present invention, but the scope of the present invention is not limited by the examples to be described below.

### Preparation Example 1

### Preparation of Acrylic Polymer A

To a 1 L reactor refluxed with nitrogen gas and equipped with a cooling system for easy regulation of temperature, 80 parts by weight of 2-ethylhexyl acrylate (2-EHA), 17 parts by weight of n-butyl acrylate (BA), and 3.0 parts by weight of 2-hydroxybutyl acrylate (2-HBA) were added, and then 100 parts by weight of ethylacetate (EAc) was added as a solvent. Next, nitrogen gas was purged for 1 hour to remove oxygen, and the temperature was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer A.

### Preparation Example 2

### Preparation of Photo-Polymerizable Acrylic Polymer A1

The acrylic polymer A prepared in Preparation Example 1 was added to a 1 L reactor refluxed with nitrogen gas and equipped with a cooling system for easy regulation of temperature, and then 3.3 parts by weight of 2-methacryloyloxy ethyl isocyanate and a proper amount of a catalyst were added to the reactor. Thereafter, while maintaining the temperature of the reactor at 40° C., 2-hr reaction was made, thereby preparing an acrylic polymer A1 into which a photo-polymerizable group is introduced.

### Preparation Example 3

### Preparation of Acrylic Polymer B

To the reactor used in Preparation Example 1, 90 parts by weight of 2-ethylhexyl acrylate (2-EHA), 5.0 parts by weight of n-butyl acrylate (BA), and 5.0 parts by weight of 2-hydroxybutyl acrylate (2-HBA) were added, and 100 parts by weight of ethylacetate(EAc) was added as a solvent. Next, nitrogen gas was purged for 1 hour to remove oxygen, and the temperature of the reactor was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer B.

### Preparation Example 4

### Preparation of Photo-Polymerizable Acrylic Polymer B1

To a reactor, 100 parts by weight of the acrylic polymer prepared in Preparation Example 3, 5.5 parts by weight of 2-methacryloyloxy isocyanate, and a proper amount of a catalyst were added, followed by 2-hr reaction at 40° C., thereby preparing a photo-polymerizable acrylic polymer B1.

### Preparation Example 5

### Preparation of Acrylic Polymer C

To a 1 L reactor equipped with a cooling system for reflux of nitrogen gas and easy regulation of temperature, 75 parts by weight of 2-ethylhexyl acrylate (2-EHA), 10 parts by weight of n-butyl acrylate (BA), and 15 parts by weight of 2-hydroxybutyl acrylate (2-HBA) were added, and then 100 parts by weight of ethylacetate (EAc) was added as a solvent. Next, nitrogen gas was purged for 1 hour to remove oxygen, and the temperature was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer C.

### Preparation Example 6

### Preparation of Photo-Polymerizable Acrylic Polymer C1

To a reactor, 100 parts by weight of the acrylic polymer prepared in Preparation Example 5, 16.5 parts by weight of 2-methacryloyloxyethyl isocyanate, and a proper amount of a catalyst were added, followed by 2-hr reaction at 40° C., thereby preparing a photo-polymerizable acrylic polymer C1.

### Preparation Example 7

### Preparation of Acrylic Polymer D

To a 1 L reactor equipped with a cooling system for reflux of nitrogen gas and easy regulation of temperature, 95 parts by weight of 2-ethylhexyl acrylate (2-EHA), 4.95 parts by weight of n-butyl acrylate (BA), and 0.05 part by weight of 2-hydroxybutyl acrylate (2-HBA) were added, and 100 parts by weight of ethylacetate (EAc) was added as a solvent. Next, nitrogen gas was purged for 1 hour to remove oxygen, and the temperature of the reactor was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer D.

### Preparation Example 8

### Preparation of Photo-Polymerizable Acrylic Polymer D1

To a reactor, 100 parts by weight of the acrylic polymer prepared in Preparation Example 7, 0.055 part by weight of 2-methacryloyloxyethyl isocyanate, and a proper amount of a catalyst were added, followed by 2-hr reaction at 40° C., thereby preparing a photo-polymerizable acrylic polymer D1.

### Preparation Example 9

### Preparation of Acrylic Polymer E

To a 1 L reactor equipped with a cooling system for reflux of nitrogen gas and easy regulation of temperature, 99.5 parts by weight of 2-ethylhexyl acrylate (2-EHA) and 0.5 part by weight of 2-hydroxybutyl acrylate (2-HBA) were added, and 100 parts by weight of ethylacetate (EAc) was added as a solvent. Next, nitrogen gas was purged for 1 hour to remove oxygen, and the temperature of the reactor was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer E.

### Preparation Example 10

### Preparation of Photo-Polymerizable Acrylic Polymer E1

To a reactor, 100 parts by weight of the acrylic polymer prepared in Preparation Example 9, 0.55 part by weight of 2-methacryloyloxyethyl isocyanate, and a proper amount of a catalyst were added. Thereafter, while maintaining the temperature of the reactor at 40° C., 2-hr reaction was made, thereby preparing an acrylic polymer E1 into which a photo-polymerizable group is introduced.

### Preparation Example 11

### Preparation of Acrylic Polymer F

To a 1 L reactor equipped with a cooling system for reflux of nitrogen gas and easy regulation of temperature, 90.9 parts by weight of 2-ethylhexyl acrylate (2-EHA), 9.0 parts by weight of n-butyl acrylate (BA), and 0.1 part by weight of 2-hydroxybutyl acrylate (2-HBA) were added, and 100 parts by weight of ethylacetate (EAc) was added as a solvent. Next, nitrogen gas was purged for 1 hour to remove oxygen, and the temperature of the reactor was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer F.

### Preparation Example 12

### Preparation of Photo-Polymerizable Acrylic Polymer F1

To a reactor equipped with a cooling system for reflux of nitrogen gas and easy regulation of temperature, the acrylic polymer F prepared in Preparation Example 11, 0.11 part by weight of 2-methacryloyloxyethyl isocyanate, and a proper amount of a catalyst were added. Thereafter, while maintaining the temperature of the reactor at 40° C., 2-hr reaction was made, thereby preparing an acrylic polymer F1 into which a photo-polymerizable group is introduced.

### Preparation Example 13

### Preparation of Acrylic Polymer G

To a 1 L reactor equipped with a cooling system for reflux of nitrogen gas and easy regulation of temperature, 89.995 parts by weight of 2-ethylhexyl acrylate (2-EHA), 10 parts by weight of n-butyl acrylate (BA), and 0.005 part by weight of 2-hydroxybutyl acrylate (2-HBA) were added, and 100 parts by weight of ethylacetate (EAc) was added as a solvent. Next, nitrogen gas was purged for 1 hour to remove oxygen, and the temperature of the reactor was kept at 55° C. Thereafter, as a reaction initiator, 0.05 part by weight of azobisisobutyronitrile (AIBN) diluted in ethylacetate to 50% was put to the reactor, followed by 8-hr reaction, thereby preparing an acrylic polymer G.

### Preparation Example 14

### Preparation of Photo-Polymerizable Acrylic Polymer G1

To a reactor equipped with a cooling system for reflux of nitrogen gas and easy regulation of temperature, the acrylic polymer G prepared in Preparation Example 13, 0.0055 part by weight of 2-methacryloyloxyethyl isocyanate, and a proper amount of a catalyst were added. Thereafter, while maintaining the temperature of the reactor at 40° C., 2-hr reaction was made, thereby preparing an acrylic polymer G1 into which a photo-polymerizable group is introduced.

### Example 1

100 parts by weight of the photo-polymerizable acrylic polymer A1, 0.5 part by weight of an antistatic agent including fatty acid alkyl ester of polyethyleneglycol and LiClO₄, and 0.5 part by weight of 1-hydroxy-cyclohexyl-penylketone (Irgacure 184, Ciba (manufacturer)) as a photo-initiator were mixed, and then diluted to a proper concentration, thereby preparing a coating liquid. Next, the coating liquid was coated on a side of biaxially-oriented PET film having a thickness of 38 μm and then dried to regulate the thickness to an about 20 μm, and then laminated to a release film. Thereafter, it is photo-polymerized by using a mercury lamp (UV B region, 280 mJ/cm²), thereby preparing a protective film.

### Examples 2 to 8 and Comparative Examples 1 to 7

Except the use of acrylic compositions based on Tables 1 and 2, protective films were prepared in the same manner as Example 1 (in Tables 1 and 2, the unit of a content is part by weight).

TABLE 1

| | Examples | | | | | | | |
|---|---|---|---|---|---|---|---|---|
| | 1 | 2 | 3 | 4 | 5 | 6 | 7 | 8 |
| Acrylic | A1 | B1 | B1 | B1 | E1 | F1 | F1 | F1 |
| Polymer | 100 | 100 | 100 | 100 | 100 | 100 | 100 | 100 |
| Photo- | — | — | — | — | 1 | 5 | — | — |
| Polymerizable | | | | | | | | |
| Compound 1 | | | | | | | | |
| (TMPTA) | | | | | | | | |
| Photo- | — | — | — | — | — | — | 1 | 5 |
| Polymerizable | | | | | | | | |
| Compound 2 | | | | | | | | |
| (PETA) | | | | | | | | |
| Antistatic | 0.5 | 0.5 | 0.1 | 1.0 | 0.5 | 0.5 | 0.1 | 1.0 |
| Agent | | | | | | | | |
| Photo-Initiator | 0.5 | 0.1 | 1.0 | 1.0 | 0.5 | 0.1 | 0.5 | 0.1 |
| Curing Agent | — | — | — | — | — | — | — | — |

Antistatic Agent: Mixture of fatty acid alkyl ester of PEG and LiClO₄
TMPTA: trimethylolpropane triacrylate
PETA: pentaerythritol tetraacrylate
Photo-Initiator: 1-hydroxycyclohexylpenylketone(Irgacure 184, Ciba(manufacturer))
Curing Agent: isocyanate curing agent(HDI)

TABLE 2

| | Comparative Examples | | | | | | |
|---|---|---|---|---|---|---|---|
| | 1 | 2 | 3 | 4 | 5 | 6 | 7 |
| Acrylic Polymer | C1 | D1 | B1 | B1 | B | G1 | F |
| | 100 | 100 | 100 | 100 | 100 | 100 | 100 |
| Photo- | — | — | — | — | — | 5 | — |
| Polymerizable | | | | | | | |
| Compound 1 | | | | | | | |
| (TMPTA) | | | | | | | |
| Photo- | — | — | — | — | — | — | — |
| Polymerizable | | | | | | | |
| Compound 2 | | | | | | | |
| (PETA) | | | | | | | |
| Antistatic Agent | 0.5 | 0.5 | 10 | 0.5 | 0.5 | 0.5 | 0.5 |
| Photo-Initiator | 0.1 | 0.1 | 0.1 | 10 | — | 0.1 | — |
| Curing Agent | — | — | — | — | 3.0 | — | 3.0 |

Antistatic Agent: Mixture of fatty acid alkyl ester of PEG and LiClO₄
TMPTA: trimethylolpropane triacrylate
PETA: pentaerythritol tetraacrylate
Photo-Initiator: 1-hydroxycyclohexylpenylketone(Irgacure 184, Ciba(manufacturer))
Curing Agent: isocyanate curing agent(HDI)

For the protective films prepared in Examples and Comparative Examples, endurance reliability, haze, peeling static voltage, peeling strength, and wettability were measured in manners described below.

### 1. Endurance Reliability Evaluation

Polarizers (200 mm×200 mm) to which the protective films prepared in Examples and Comparative Examples are attached are left in high-temperature condition (heat resistance condition) (80° C., 1,000 hours) and high-temperature and high-humidity condition (moisture and heat resistances) (60° C., 90% R.H., 1,000 hours), after which it was observed whether lifting or peeling occurred in pressure-sensitive adhesive surfaces and endurance reliability was evaluated according to the following criteria:

∘: No bubble or release phenomenon was observed.

Δ: A few bubbles or release phenomenon occurred.

x: A large quantity of bubbles or release phenomenon occurred.

### 2. Haze Measurement

The protective films prepared in Examples and Comparative Examples are cut into a size of 40 mm×70 mm to prepare specimens, and haze was evaluated according to JIS K7150 and ASTM D1003-95. More specifically, diffused transmission (Td) and total transmitted light (Ti) were measured and haze was defined by a percentage of Td with respect to Ti. Thereafter, the specimens were left at a temperature of 60° C. and at a relative humidity of 90% for 1,000 hours, and the haze was measured in the same manner, after which the hazes before and after the preservation were compared to evaluate whitening.

### 3. Peeling Static Voltage Evaluation

The protective films prepared in Examples and Comparative Examples were adhered to anti-glare layer surfaces (AG, Japan DNP (manufacturer)) of polarizers by using a 2 Kg roller, and then kept at a temperature of 23∪ C. and at a relative humidity of 50% for 24 hours (specimen size: 22 cm×24 cm). Thereafter, while peeling the protective films adhered to the specimens at a speed of 40 m/min, static voltage generated on the polarizer surfaces was measured by using a static voltage measurer (STATIRON-M2) positioned 2 cm above the polarizer surfaces. In the same way, the static voltage was measured 10 times and an average value thereof was shown in Table 2.

### 4. 180° Peeling Strength Evaluation

The protective films prepared in Examples and Comparative Examples were adhered to anti-glare layer surfaces (AG, Japan DNP (manufacturer)) of polarizers by using a 2 Kg roller according to JIS Z 0237, and then kept a temperature of 23° C. and at a relative humidity of 60% for 24 hours. Thereafter, by using a tensile tester, peeling strength was measured at a peeling angle of 180° and peeling speeds of 0.3 m/min and 30.0 m/min

### 5. Wettability Evaluation

The protective films prepared in Examples and Comparative Examples were adhered to anti-glare layer surfaces (AG, Japan DNP (manufacturer)) of polarizers by using a 2 Kg roller according to JIS Z 0237. Then they were left at temperature of 23° C. and at a relative humidity of 65% for 24 hours, and then cut into a size of 25 cm×2.5 cm to prepare specimens. One side of the protective films from the specimens were peeled with leaving about 1 cm from the opposite side, and then the protective films were softly released to measure a time for which the protective films were adhered again.

∘: The time required for re-adhesion is less than 10 seconds

x: The time required for re-adhesion is in excess of 10 seconds

The foregoing measurement results are shown in Table 3.

TABLE 3

| | | Endurance | | | | Peeling | | |
|---|---|---|---|---|---|---|---|---|
| | | Reliability | | | | Static | Peeling Strength | |
| | | Heat | Moisture | Haze | | Voltage | (gf/25 mm) | |
| | | Resistance | Resistance | (%) | Wettability | (kV) | 0.3 m/min | 30 m/min |
| Examples | 1 | ∘ | ∘ | 0.3 | ∘ | 0.2 | 5 | 50 |
| | 2 | ∘ | ∘ | 0.2 | ∘ | 0.2 | 6 | 55 |
| | 3 | ∘ | ∘ | 0.3 | ∘ | 0.3 | 8 | 60 |
| | 4 | ∘ | ∘ | 0.2 | ∘ | 0.1 | 5 | 45 |
| | 5 | ∘ | ∘ | 0.3 | ∘ | 0.2 | 5 | 50 |
| | 6 | ∘ | ∘ | 0.2 | ∘ | 0.2 | 6 | 55 |
| | 7 | ∘ | ∘ | 0.3 | ∘ | 0.3 | 8 | 60 |
| | 8 | ∘ | ∘ | 0.2 | ∘ | 0.1 | 5 | 45 |
| Comparative | 1 | x | x | 0.2 | x | 0.3 | 2 | 20 |
| Examples | 2 | ∘ | ∘ | 0.3 | ∘ | 0.4 | 13 | 150 |
| | 3 | x | x | 0.2 | ∘ | 0.1 | 2 | 60 |
| | 4 | x | x | 0.3 | x | 0.2 | 2 | 30 |
| | 5 | ∘ | ∘ | 0.3 | Impossible | Impossible | Impossible | Impossible |
| | | | | | to | to | to | to |
| | | | | | measure | measure | measure | measure |
| | 6 | x | x | 0.3 | x | 0.2 | 2 | 30 |
| | 7 | ∘ | ∘ | 0.3 | Impossible | Impossible | Impossible | Impossible |
| | | | | | to | to | to | to |
| | | | | | measure | measure | measure | measure |

As can be seen from Table 2, Examples 1 to 4 according to the present invention satisfy superior anti-static property, transparency, endurance reliability, and pressure-sensitive adhesion property at the same time, thereby being efficiently applicable to various display devices.

On the other hand, Comparative Example 1 having a high content of a photo-polymerizable group in an acrylic polymer has poor endurance reliability and wettability due to excessive increase in the cohesive strength of the pressure-sensitive adhesive layer, whereas Comparative Example 2 having a low content of the photo-polymerizable group undergoes excessive increase in high-speed and low-speed peeling strengths, from which the processing efficiency is expected to be lowered. Comparative Example 3 having an excessive amount of an antistatic agent added thereto has a problem in endurance reliability, and Comparative Example 4 having an excessive amount of a polymerizable initiator added thereto experiences significant degradation in endurance reliability. In Comparative Example 6 having an excessively small amount of a photo-activating group in the photo-polymerizable acrylic polymer, in spite of addition of the photo-polymerizable compound for reinforcing cohesive strength, the peeling strength excessively increases and the peeling processing efficiency was degraded due to a lack of cohesive strength.

1. An acrylic composition for optical elements, comprising:
100 parts by weight of a photo-polymerizable acrylic polymer, the photo-polymerizable acrylic polymer comprising a main chain which is a polymer of a monomer mixture comprising 90 to 99.9 parts by weight of a (meth)acrylic acid ester monomer and 0.01 to 10 parts by weight of a polar monomer; and 0.06 to 16 parts by weight of a photo-polymerizable group-containing compound bonded to the main chain;
0.01 to 9 parts by weight of an antistatic agent; and
0.01 to 9 parts by weight of a polymerization initiator.

2. The acrylic composition of claim 1, wherein the (meth)acrylic acid ester monomer is alkyl (meth)acrylate comprising an alkyl group having 1 to 14 carbon atoms.

3. The acrylic composition of claim 1, wherein the polar monomer comprises a hydroxy group, a carboxyl group, an isocyanate group, an amino group, or an epoxy group.

4. The acrylic composition of claim 1, wherein the photo-polymerizable group-containing compound is one or more selected from a group consisting of 2-isocyanatoethyl (meth)acrylate, 1,1-bis(acryloyloxymethyl)ethyl isocyanate, (meth)acryloyloxyethyl isocyanate, metha-isopropenyl-α,α-dimethylbenzylisocyanate, methacryloylisocyanate, allyl isocyanate; acryloyl monoisocyanate compound; (meth)acrylic acid glycidyl; (meth)acrylic acid; and 3-methacryloxypropyldimethylchlorosilane.

5. The acrylic composition of claim 1, wherein the photo-polymerizable acrylic polymer has a weight average molecular weight of 200,000 to 1,000,000.

6. The acrylic composition of claim 1, wherein the antistatic agent is i) a mixture of an alkyleneoxide-containing compound and metal salt; or ii) a mixture of a compound capable of forming a coordinate covalent bond and metal salt.

7. The acrylic composition of claim 6, wherein the alkyleneoxide-containing compound is expressed by: 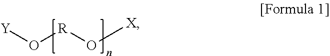
where R represents alkylene, Y represents hydrogen, alkyl, or —C(═O)R₁, X represents hydrogen, hydroxy, alkyl, or —C(═O)R₂, and n represents 1 to 120, in which R₁ and R₂ represent independently hydrogen or an alkyl group.

8. The acrylic composition of claim 6, wherein an alkyleneoxide-containing compound is polyalkyleneglycol, fatty acid alkyl ester of polyalkyleneglycol, or carboxyl acid ester of polyalkyleneglycol.

9. The acrylic composition of claim 6, wherein the alkyleneoxide-containing compound has a weight average molecular weight of 100 to 10,000.

10. The acrylic composition of claim 6, wherein the compound capable of forming a coordinate covalent bond is one or more selected from a group consisting of an oxalate group-containing compound, a diamine group-containing compound, a polyvalent carboxyl group-containing compound, and a B-ketone group-containing compound.

11. The acrylic composition of claim 10, wherein the oxalate group-containing compound is diethyloxalate, dimethyloxalate, dibutyloxalate, di-tert-butyloxalate, or bis(4-methylbenzyl)oxalate; the diamine group-containing compound is ethylenediamine, 1,2-diaminopropane, or diaminobutane; the polyvalentcarboxyl group-containing compound is ethylenediamine-N,N,N′,N′-tetraacetic acid, N,N,N′,N″,N″-diethylenetriamine pentaacetic acid, 1,4,7,10-tetraazacyclododecane-N,N′,N″,N′″-tetraacetic acid, 1,4,7,10-tetraazacyclododecane-N,N′,N″-triacetic acid, trans(1,2)-cyclohexanodiethylenetriamine pentaacetic acid, or N,N-biscarboxymethylglycine; and the β-ketone group-containing compound is 2,4-pentadion, 1-bezoylacetone, or ethylacetoacetate.

12. The acrylic composition of claim 6, wherein the metal salt comprises one or more cations selected from a group consisting of Li⁺, Na⁺, K⁺, Rb⁺, Cs⁺, Be²⁺, Mg²⁺, Ca²⁺, Sr²⁺, and Ba²⁺; and one or more anions selected from a group consisting of F⁻, Cl⁻, Br⁻, I⁻, ClO₄⁻, OH⁻, CO₃²⁻, CH₃CO₂⁻, N₃⁻, HPO₄²⁻, NO₃⁻, SO₄²⁻, CH₃(C₆H₄)SO₃⁻CH₃C₆H₄SO₃⁻, COOH(C₆H₄)SO₃⁻, CF₃SO₂⁻, C₆H₅COO⁻, CH₃COO⁻, CF₃COO⁻, BF₄⁻, B(C₆H₅)₄⁻, PF₆⁻, P(C₂F₅)₃F₃⁻)⁻, N(SO₂CF₃)₂⁻, N(SOC₂F₅)₂⁻, N(COC₂F₅)₂⁻, N(COC₂F₅)₂⁻, N(SO₂C₄F₉)₂⁻, N(COC₄F₉)₂⁻, C(SO₂CF₃)₃⁻, and C(SO₂CF₃)₃⁻.

13. The acrylic composition of claim 1, wherein the polymerization initiator is a bezoin compound, hydroxy ketone compound, an amino ketone compound, or a phosphine oxide compound.

14. The acrylic composition of claim 1, further comprising 0.1 to 10 parts by weight of a photo-polymerizable compound relative to 100 parts by weight of the acrylic polymer.

15. The acrylic composition of claim 14, wherein the photo-polymerizable compound is multifunctional acrylate, urethane acrylate oligomer, or epoxy acrylate oligomer.

16. A protective film for optical elements, the protective film comprising:
a base; and
a pressure-sensitive adhesive layer comprising a cured product of the acrylic composition according to claim 1, the pressure-sensitive adhesive layer being formed on the base.

17. The protective film of claim 16, wherein a thickness of the base is 5 to 500 μm

18. The protective film of claim 16, wherein a thickness of a pressure-sensitive adhesive layer is 2 to 100 μm

19. A polarizer comprising the protective film according to claim 16, the protective film being attached on one side or both sides of the polarizer.

20. A liquid crystal display having the polarizer according to claim 19 attached on a side or both sides of a liquid crystal panel.
